(19) United States
(12) Patent Application Publication
(10) Pub. No.: US 2012/0119644 A1
(43) Pub. Date: May 17, 2012

(54) Xenon short arc lamp

(75) Inventors: Masahiro Shimozato, Hyogo (JP); Yoichi Kono, Hyogo (JP)

(73) Assignee: USHIO DENKI KABUSHIKI KAISHA, Tokyo (JP)

(21) Appl. No.: 13/317,937

(22) Filed: Nov. 1, 2011

(30) Foreign Application Priority Data
Nov. 17, 2010 (JP) 2010-256436

(51) Int. Cl. H01J 61/36; H01J 61/16

(52) U.S. Cl. 313/623

(57) ABSTRACT

A xenon short-arc lamp includes an arc tube containing a first electrode and a second electrode, sealing tubes on both edges of the arc tube and supporting tubes that are supported in the sealing tubes. Core rods of the first electrode and the second electrode are inserted through and supported by the supporting tubes. A high alternating voltage is applied at the start of the lighting. A trigger wire that is electrically connected to the first electrode is wound around an outer surface of the second electrode side sealing tube at an arc tube side position other than a location of the sealing tube that faces the metal foil. The trigger wire may be wound around an rising part of the arc tube.

### CROSS-REFERENCES TO RELATED APPLICATION

This application claims priority from Japanese Patent Application Serial No. 2010-256436 filed Nov. 17, 2010, the contents of which are incorporated herein by reference in their entirety.

### TECHNICAL FIELD

The present invention pertains to a xenon short-arc lamp, mounted on projection devices, such as projectors, wherein the xenon short-arc lamp is comprised of a supporting tube that supports electrodes in the sealing tube.

### BACKGROUND

From the past, xenon short-arc lamps have been used as a light source to be mounted on projective devices, such as projectors. This xenon short-arc lamp has a spherical or oval spherical shaped arc tube made of quartz glass where xenon gas is filled and an anode and a cathode are positioned to face each other. The core rods of the cathode and the anode are sealed at the edge of the sealing tube, which are extended on both sides of the arc tube. To avoid an excessive load on the sealed parts, in general, a structure that supports the core rods of the cathode and the anode at the sealing tube has been employed, and narrowed parts, where the edge of the sealing tube on the arc tube side is heated to reduce the diameter, are formed to support the rods of the cathode and anode. However, to directly support the electrode core rods of the cathode and anode at the narrowed parts of the sealing tube, the amount to be narrowed needs to be significantly large. When the amount to be narrowed is large, the narrowing operation is difficult, and at the same time, when the sealing tube is deformed significantly, stress is generated at the portion, and it sometimes breaks.

Therefore, a structure has been employed to reduce the amount of narrowing by providing a supporting tube made of quartz glass where the core rods of the cathode and the anode are inserted and supported and by narrowing the diameter of said sealing tube in the direction of the supporting tube. However, when the narrowed parts are formed on the sealing tube and if both the material of the narrowed parts and the supporting tube are fused and combined, there is a risk that a crack will form on the supporting tube. To avoid this problem, a structure in which metal foil is wound around the outer circumference of the supporting tube, has been employed. By doing so, fusing and combining of both the material of the narrowed parts and the supporting tube can be avoided and thus undesirable stress is not applied to the sealing tube, allowing which prevents cracks from forming. The structure of such a xenon short-arc lamp is listed in Japanese Patent No. 3430887.

Recently, it has been strongly desired to intensify the brightness of the projected images and therefore, there is a trend to increase the amount of the enclosed xenon gas, and inevitably, the breakdown voltage becomes higher. A structure where a trigger wire is provided on the outer service of the arc tube to reduce this breakdown voltage has been known. The structure of such a xenon short-arc lamp is listed in Unexamined Application Publication No. 2009-289454.

FIG. 3 is a cross-sectional view of the background art. FIG. 3 shows its structure. The xenon short-arc lamp is comprised of an arc tube 2 made of quartz glass and sealing tubes 3 on both edges. Inside the arc tube 2, a cathode 4 and an anode 5 are positioned to face each other. In said sealing tubes 3, supporting tubes 6 and 6, which are made of quartz glass, are positioned and a core rod 4a of said cathode 4 and core rod 5a of said anode 5 are inserted to support the electrodes 4 and 5. These supporting tubes 6 and 6 are supported by narrowed parts 7 and 7, which are formed by heating the sealing tubes 3. A metal foil 10 is wound around the outer circumference of said supporting tube 6, so that it does not fuse with the narrowed part 7 of the sealing tube 3. A trigger wire 8 that is electrically connected to the anode 5 on one edge is provided along the sealing tube 3 and the arc tube 2, and a ring 9 on the opposite end is provided in a manner that wraps around the arc tube 2.

Such a xenon short-arc lamp starts by applying a high alternating voltage between the electrodes by an igniter. In accordance with the above-mentioned structure, even if the ring 9 of the trigger wire 8 is positioned between the electrode, or adjacent to the cathode 4, when the pressure of the enclosed xenon gas that is enclosed to intensify the light output is increased, the electric field between the electrode cannot be sufficiently distorted enough. Therefore, even if a high alternating voltage is applied, the lamp does not start. To solve such a problem, a structure such that the edge of the trigger wire, which is electrically connected to one of the electrodes, is wound around the narrowed parts, has been developed as shown in FIG. 4.

FIG. 4 is a cross-sectional view of the background art. In other words, as shown in FIG. 4, the ring 9, which is the opposite end of the trigger wire 8 that is electrically connected to the anode 4, is wound around the narrowed part 7 of the sealing tube 3 that is formed on the outer circumference of the supporting tube 6, which supports the anode 4. By having such a structure, the ring 9 of the trigger wire 8 separates from the cathode 4 and separates from between the electrodes allowing the electric field between the electrodes to be sufficiently distorted.

However, this structure is found to have another problem. The trigger wire 8 is electrically connected to one of the electrodes (anode) 5 and therefore, at the start, a high alternating voltage is applied to said trigger wire 8 as well.

FIG. 5 is a magnified cross-sectional view of the background art. The state shown in FIG. 5 is the state where a positive high voltage is applied to the trigger wire 8. The outer surface 3a of the sealing tube 3, which comes in contact with the trigger 8, is electrically charged with a negative charge, and the inner surface 3b of the sealing tube 3 is electrically charged with a positive charge. At the same time, on the surface of the metal foil 10, which is wound around the outer surface of the supporting tube 6 positioned adjacent to the inner surface 3b of the sealing tube 3 that is electrically charged with a positive charge, a negative charge is induced by the coulomb force. In other words, the inner surface 3b of the sealing tube 3 is electrically charged with a positive charge, and the metal foil 10 is electrically charged with a negative charge, and an abnormal electric discharge 11 is generated between the inner surface 3b of the sealing tube 3 and metal foil 10 via the xenon gas that exists in between. Then, the polarity of the high voltage that is applied from the igniter is inverted and the positive high voltage is applied to the cathode 4. Further, the trigger wire 8 is negatively polarized and the inner surface 3b of the sealing tube 3 is electrically charged with a negative charge. Furthermore, the metal foil 10 is electrically charged with a positive charge, and the next abnormal electric discharge 11 is generated between the inner surface 3b of the sealing tube 3 and the metal foil 10.

Thus, the a problem of inconsistent lamp starts exists do to a portion of the energy being spent by the abnormal electric discharge generated between the inner surface of the sealing tube and the metal foil even if a high alternating voltage is applied between the electrodes at the start.

### SUMMARY

The objective is to provide a xenon short-arc lamp that includes an arc tube containing a first electrode and a second electrode, sealing tubes on both edges of the arc tube and supporting tubes that are supported in the sealing tubes. Core rods of the first electrode and the second electrode are inserted through and supported by the supporting tubes. A high alternating voltage is applied at the start of the lighting. A trigger wire that is electrically connected to the first electrode is wound around an outer surface of the second electrode side sealing tube at an arc tube side position other than a location of the sealing tube that faces the metal foil.

Further, the trigger wire may be wound around a rising part of the arc tube.

### BRIEF DESCRIPTION OF THE DRAWINGS

FIG. 1 is an overall view of an example of a xenon arc lamp.

FIG. 2 is a magnified view of the essential parts of an example of a xenon arc lamp.

FIG. 3 is a cross-sectional view of the background art.

FIG. 4 is a cross-sectional view of the background art.

FIG. 5 is a magnified cross-sectional view of the background art.

### DESCRIPTION

Given the problem of the above-mentioned background art, the present invention is a xenon short-arc lamp comprised of an arc tube where the electrodes (an anode and a cathode) are positioned to face each other, sealing tubes are located on both edges of the arc tube, and supporting tubes are supported in the sealing tubes. Further, a metal foil is wound around the outer circumference of the supporting tube. Core rods of the electrodes are inserted through and supported by the supporting tubes. A high alternating voltage is applied at the start of the lighting, and an abnormal electric discharge between the sealing tube and the metal foil on the surface of the supporting tube is prevented.

Further, the present invention has a trigger wire that is electrically connected to one of the above-mentioned electrodes by being wound at a position at the outer surface of the sealing tube at the arc tube side compared to the position where it faces with the metal foil of said supporting tube of the sealing tube on the other electrode side. The other edge of the trigger wire that is electrically connected to one of the electrodes is wound at a position that is shifted towards the arc tube side from the metal foil of the supporting tube. Therefore, the distance between the position of the edge of said trigger wire and the metal foil on the outer surface of the supporting tube increases, and when a high alternating voltage is applied at the start of lighting the lamp, no abnormal electric discharge is generated between the inner surface of the sealing tube and the metal foil of the supporting tube, which allows all the energy of the applied voltage to be used for the start. This structure assures that the xenon short-arc lamp will start.

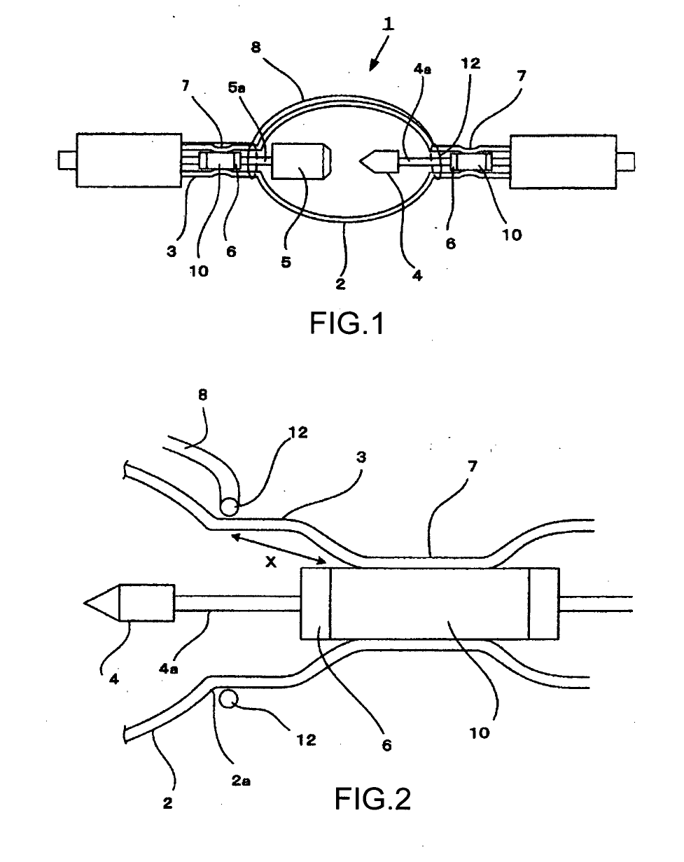

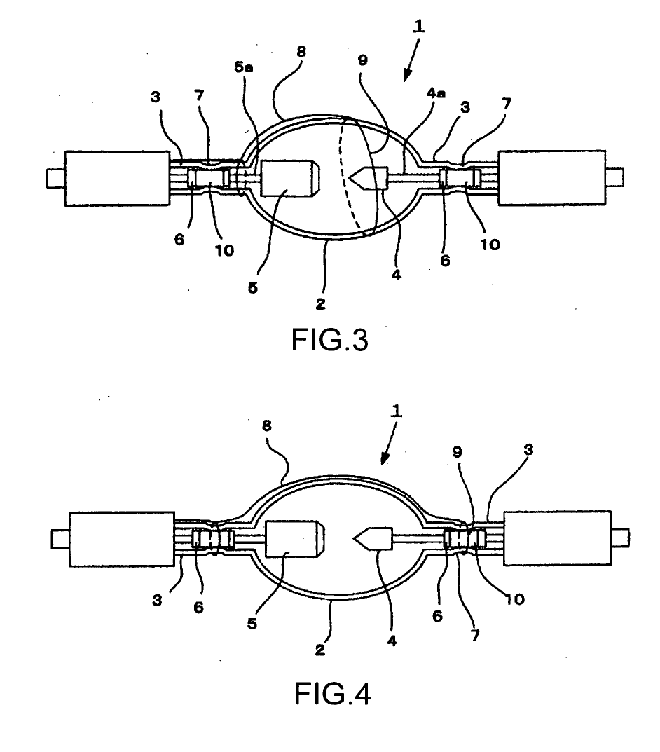

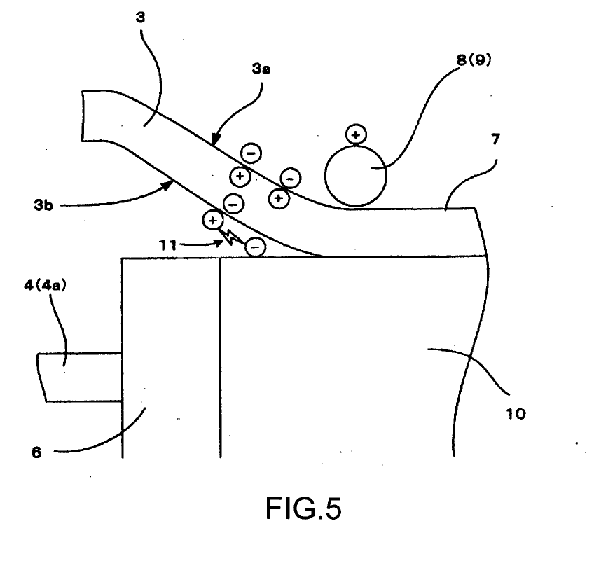

FIG. 1 is an overall view of an example of a xenon arc lamp. In FIG. 1, the xenon short-arc lamp is comprised of an arc tube 2 and sealing tubes 3. Inside the arc tube 2, there is a cathode 4 and an anode 5. In the sealing tubes 3, there is supporting tubes 6, a core rod 4a of said cathode 4, and a core rod 5a of said anode 5. On the outer surface of said supporting tube 6, a metal foil 10 is wrapped around and is supported by the narrowed part 7 of the sealing tube 3. The trigger wire 8, which is electrically connected to the anode 5, is provided along the arc tube 2.

FIG. 2 is a magnified view of the essential parts of an example of a xenon arc lamp. As shown in FIG. 2 in detail, the ring 12 on the other end of the cathode 4 side of the above-mentioned trigger wire 8 is wound around at a position at the outer surface of the sealing tube 3 close to the arc tube 2 side as compared to the position where the sealing tube 3 faces with the metal foil 10 that wraps the supporting tube 6. It is desirable that the position of the ring 12 of the trigger wire 8 is as far from said metal foil 10 as possible. It is preferable that the ring 12 is wound around, or positioned at, the rising part 2a of the arc tube 2 continuing from the sealing tube 3.

By having the above-mentioned structure, as the distance X between the location where the ring 12 at the end of the trigger wire 8 and the metal foil 10 on the outer surface of the supporting tube 6 increases, an abnormal discharge is prevented from being generated. In the above example, although one end of the trigger wire 8 is electrically connected to the anode 5 while the other end is electrically free, this can be reversed. That is, one end of the trigger wire 8 may be electrically connected to the cathode 4 and the other end may be electrically free. In this case, the ring 12 at the end on the anode 5 side should be wound around at a position at an outer surface of an anode side sealing tube 3 at the arc tube 2 side apart from a position of the anode side sealing tube 3 where it faces with the metal foil 10 that covers or wraps around the supporting tube 6 at the anode side.

As described above, the trigger wire 8, the one end of which is electrically connected to one of the electrodes (the anode and the cathode), is provided along the arc tube, and is wound around the outer surface of the sealing tube 3 of the other electrode side at the arc tube connecting part apart from the metal foil 10 that wraps the supporting tube 6 on the other electrode side. Therefore, the distance between the trigger wire 8 and the metal foil 10 increases and an abnormal discharge may not be generated. Thus, by doing so, when an alternating high-voltage is applied at the startup, the energy is not spent by an undesirable abnormal discharge and startup is assured.

The preceding description has been presented only to illustrate and describe exemplary embodiments of the present xenon short-arc lamp. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A xenon short-arc lamp, to which a high alternating voltage is applied at a start of lighting, comprising:
an arc tube containing a first electrode and a second electrode, the first electrode and the second electrode face each other and are each supported by first and second supporting tubes respectively, wherein a metal foil is wound around the outer circumference of the supporting tube;
first and second sealing tubes extending from both edges of the arc tube, the first and second supporting tubes are supported in said first and second sealing tubes respectively; and
a trigger wire that is electrically connected to the first electrode is wound around an outer surface of the second sealing tube at an arc tube side position other than a location of the second sealing tube that faces the metal foil.

2. A xenon short-arc lamp according to claim 1, wherein the trigger wire is wound around an rising part of the arc tube.
